(19) United States
(12) Patent Application Publication
(10) Pub. No.: US 2008/0060406 A1
(43) Pub. Date: Mar. 13, 2008

(54) Method of and apparatus for forming a hollow step profiled shaft

(75) Inventors: Shigeaki Yamanaka, Hiroshima (JP); Takeshi Kazama, Hiroshima (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KUBOTA IRON WORKS CO., LTD., Hiroshima (JP)

(21) Appl. No.: 11/900,568

(22) Filed: Sep. 12, 2007

(30) Foreign Application Priority Data
Sep. 13, 2006 (JP) 2006-247672

(51) Int. Cl. B21D 22/06; B21D 53/84; B21K 1/12; F16H 53/02

(52) U.S. Cl. 72/353.2; 29/888.1

(57) ABSTRACT

A hollow step-profiled shaft such as a cam shaft that is high in accuracy and excellent in productivity and requires little post-machining is being formed. To this end, a hollow stepped shaft 8 having its axis and large diameter portions 9a-12b intermediate axially between its ends is formed by a forming process in which each large diameter portion of the shaft is compressed with forming dies 32a-32d from at least three different directions approximately simultaneously towards the axis to shape the large diameter portion with a profile such as to conform to contours 38a-38d of a cavity 38 formed in a region of tips of the forming dies 32a-32d.

### TECHNICAL FIELD

The present invention relates to a method of and an apparatus for forming a hollow step-profiled shaft, e.g., a hollow cam shaft used generally in automotive engines, that is a hollow shaft having stepped portions, e.g., as cams, which are non-circular and profiled in cross-section, intermediate axially between its ends.

### BACKGROUND ART

For example, as a cam shaft for driving inlet and exhaust valves in a motor vehicle engine, there is a hollow cam shaft that is made from a hollow blank for weight saving and having step-profiled portions as cams which are bulged by bulging from their inside and thereby formed (see, for example, JP P 2000-192805 A).

Also, as a hollow cam shaft, there is also known that of cast iron (steel) which is molded by casting a molten metal into a cavity having a rod-like core in the form of a cam shaft disposed therein (see, for example, JP P H05-26007 A).

In the above method in which cam portions are bulged from the inside of a hollow blank, split forming dies designed for parts for portions including cam face forming portions and parts for other portions are used and a liquid pressure is acted on the inside of the hollow blank while each of the forming dies is being moved. Thus, a high liquid pressure must be applied within the hollow of the blank while the forming dies are being moved and with the bulged blank becoming too thin locally at cam face portions, building as post machining must be performed on those portions to correct the bulged product. As a result, the method has been poor in productivity and proves unsuitable for mass production as it now stands.

In the above method of casting, cam faces of a hollow cam shaft are chilled and an awful shape correction of these portions has been necessary. This method of forming has thus been poor in productivity, too.

In view of the above, it is an object of the present invention to provide a method of and an apparatus for forming a hollow step profiled shaft whereby hollow step-profiled shafts which make it almost unnecessary to perform post-machining for shape correction can be formed less costly and with high precision and enhanced productivity.

### DISCLOSURE OF THE INVENTION

In order to achieve the object mentioned above, there is provided in accordance with the present invention in a first form of implementation thereof a method of forming a hollow step-profiled shaft, which comprises the steps of: preparing a hollow stepped shaft having its axis and large diameter portions intermediate axially between its ends; compressing a large diameter portion of the shaft with forming dies from at least three different directions approximately simultaneously towards the axis; and shaping the large diameter portion with a profile such as to conform to contours of a cavity formed in a region of tips of the forming dies.

The present invention also provides in a second form of implementation thereof a method of forming a hollow step-profiled shaft, which comprises the steps of: preparing a hollow stepped shaft having its axis and a plurality of large diameter portions intermediate axially between its ends; disposing the hollow stepped shaft in a forming die unit so as to be movable axially and coaxially therewith, the forming die unit having forming dies movable in at least three different directions towards and away from the axis, the forming dies being formed with a cavity in a region of their tips; moving the hollow stepped shaft axially and coaxially with the forming die unit to bring the large diameter portions successively into juxtaposition with the forming dies in the forming die unit; and when each of the large diameter portions is brought into juxtaposition with the forming dies, compressing the large diameter portion of the shaft with the forming dies from at least three different directions approximately simultaneously towards the axis to shape the large diameter portion with a profile such as to conform to contours of the cavity.

And, as a third form of implementation thereof the present invention features that in a method of forming a hollow step-profiled shaft in accordance with the first or second form of implementation above, the forming dies includes a first forming die for forming a portion of profile that is larger than a diameter of the large diameter portion and a second forming die for forming another portion of profile that is smaller than the diameter of the large diameter portion and that the first forming die is operated in precedence to the second forming die.

Also, as a fourth form of implementation thereof the present invention features that in a method of forming a hollow step-profiled shaft in accordance with the second form of implementation above, each succeeding large diameter portion is formed with a profile upon rotating the hollow stepped shaft by a selected angle about the axis to alter a forming position for its preceding large diameter portion.

Further, as a fifth form of implementation thereof the present invention features that in a method of forming a hollow step-profiled shaft in accordance with any one of the first to fourth forms of implementation above, the hollow stepped shaft has a mandrel inserted in its hollow when a large diameter portion thereon is formed with a profile. Also, in a method of forming a hollow step-profiled shaft in accordance with the first form or the second form of implementation above, the forming die moves in three or four or at least five different directions, respectively.

And, the present invention provides in a sixth form of implementation thereof an apparatus for forming a hollow step-profiled shaft from a hollow stepped shaft having its axis and large diameter portions axially intermediate between its ends, which for carrying out a method as mentioned above comprises: a support member disposed on a bolster in a pressing machine for supporting the lower end of the hollow stepped shaft; a holder means mounted to a slide in the pressing machine for holding the upper end of the hollow stepped shaft; and a forming die unit disposed on the bolster and having forming dies movable in at least three different directions towards and away from the axis, the forming dies being formed with a cavity in a region of their tips, and a cylinder unit for operating the forming dies.

There is also provided in accordance with the present invention in a seventh form of implementation thereof an apparatus for forming a hollow step-profiled shaft from a hollow stepped shaft having its axis and large diameter portions axially intermediate between its ends, which for carrying out a method as mentioned above comprises: a step-profiled portion forming apparatus comprising a base block secured to a bolster in a pressing machine having a slide, a knockout cylinder mounted in the bolster, an axial knockout movable up and down by the knockout cylinder and controllable of its vertical position in synchronism with movement of the slide, and a forming die unit disposed above the base block coaxially with the axial knockout and having forming dies movable in at least three different directions towards and away from the axis, the forming dies being formed with a cavity in a region of their tips, and a cylinder unit for operating the forming dies; and a holder means attached to the slide for holding an upper end of the hollow stepped shaft supported on the knockout.

And, as an eighth form of implementation thereof the present invention features that in an apparatus for forming a hollow step-profiled shaft in accordance with the seventh form of implementation above, there is further provided an indexing means coupled to the holder means so that it is capable of rotating the holder mean about its axis for indexing.

And, as an ninth form of implementation thereof the present invention features that in an apparatus for forming a hollow step-profiled shaft in accordance with the seventh or eighth form of implementation above, there are further provided a mandrel passed through the axial knockout for insertion into the hollow of the hollow stepped shaft and a mandrel supporting block disposed in the step-profiled portion forming apparatus. Also, in an apparatus of forming a hollow step-profiled shaft in accordance with the sixth form or the seventh form of implementation above, the forming die moves in three or four or at least five different directions, respectively.

According to a method of forming a hollow step-profiled shaft in accordance with the first form of implementation of the present invention, a large diameter portion of a hollow stepped shaft having large diameter portions intermediate axially between its ends can be shaped with a profile conforming to contours of a cavity formed in a region of tips of forming dies by the forming die in a single stroke of their compression operation. Thus, a cam face with a selected profile on a hollow stepped shaft can be shaped in a short period of time and to an extent that requires little post-machining.

And, according to a method of forming a hollow step-profiled shaft in accordance with the second form of implementation of the present invention, a plurality of large diameter portions of a hollow stepped shaft having the large diameter portions intermediate axially between its ends can be shaped successively and efficiently in a forming die unit upon moving the stepped portions of the shaft axially and bringing the large diameter portions successively into juxtaposition with the forming die unit.

Also, according to a method of forming a hollow step-profiled shaft in accordance with the third form of implementation of the present invention, a large diameter portion may be formed with a cam profile on a cam shaft for an automotive engine wherein a base circle section that becomes smaller than the diameter of the large diameter portion can first be formed and a cam face section that becomes larger than the diameter of the large diameter portion can later be formed. This permits material to be forced out of the base circle section to be moved into the cam face section and then a proportion of material of the cam face section to be formed. Material in the large diameter portion can be forged as closed within a profiled cavity formed in a region of tips of the forming dies and formed into a cam profile such as to conform to contours of the cavity.

Also, according to a method of forming a hollow step-profiled shaft in accordance with the fourth form of implementation of the present invention, a hollow stepped shaft can be rotated over a selected angle about its axis each time of forming each large diameter portion with a profile by the forming die unit to alter in each step the phase about the axis of a profile changing from one step to another. This permits efficiently forming a hollow cam shaft for an automotive engine with a plurality of cylinders which needs shaping cams thereof with a profile whose phase changes from one step to another.

Also, according to a method of forming a hollow step-profiled shaft in accordance with the fifth form of implementation of the present invention, inserting a mandrel into the hollow of a hollow stepped shaft allows each stepped large diameter portion to be shaped with a profile on the hollow stepped shaft without having a deformation of its blank profile.

Also, according to an apparatus for forming a hollow step-profiled shaft in accordance with any one of the sixth to ninth forms of implementation of the present invention, forming of each step-profiled portion on the hollow step-profiled shaft by a forming method in accordance with any one of the first and fifth forms of implementation above can be effected efficiently in a short period of time. And, especially according to a forming apparatus in accordance with the eighth form of implementation of the present invention, the hollow step-profiled shaft held by the holder means can be rotated by an accurate angle about the axis for indexing each time of forming each stepped large diameter portion with a profile whereby cams on an automotive hollow cam shaft which vary in cam angle about the axis from one axial position to another can be shaped upon accurately indexing their different angular positions.

### BRIEF DESCRIPTION OF THE DRAWINGS

In the drawings,

FIG. 1 is a perspective view illustrating a typical hollow cam shaft as a hollow step-profiled shaft to be formed by a method of the present invention;

FIG. 2 is a longitudinal sectional view illustrating a hollow stepped shaft becoming the hollow cam shaft and the method of forming the same;

FIG. 3 is a longitudinal sectional view in part fragmentary of a hollow shaft as a blank of the hollow stepped shaft;

FIG. 4 is a longitudinal sectional view diagrammatically illustrating a cam forming apparatus to carry out the method of the pre-sent invention;

FIG. 5 is a cross sectional view illustrating the cam forming apparatus in a die opening state; and

FIG. 6 is a cross sectional view illustrating the cam forming apparatus in a state of forming a cam.

### BEST MODES FOR CARRYING OUT THE INVENTION

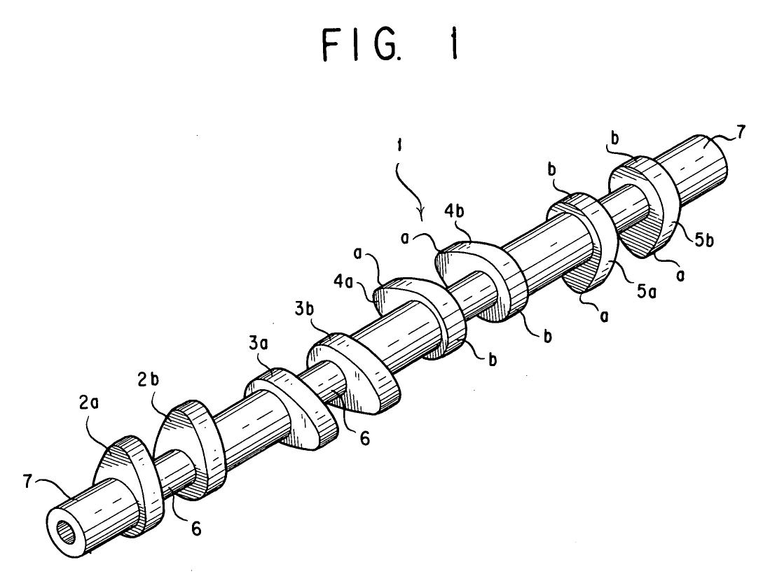

FIG. 1 shows a typical hollow cam shaft 1 as a hollow step-profiled shaft to be formed by a method of the present invention. The hollow cam shaft 1 is a component for operating inlet and exhaust valves in an automotive engine having a plurality of cylinders and is provided e.g., at four axial places with a first pair of cams 2a and 2b, a second pair of cams 3a and 3b, a third pair of cams 4a and 4b and a fourth pair of cams 6a and 5b, respectively, wherein the cams are mounted about an axis with a varying angle for each pair. Lying between the cams in each pair is a journal portion 6. The cams in each pair are identical in shape and are arranged symmetrically with respect to a line connecting apexes of a cam face section a and a base circle section b. Further, the hollow cam shaft 1 is provided at its opposite ends with axial end portions 7.

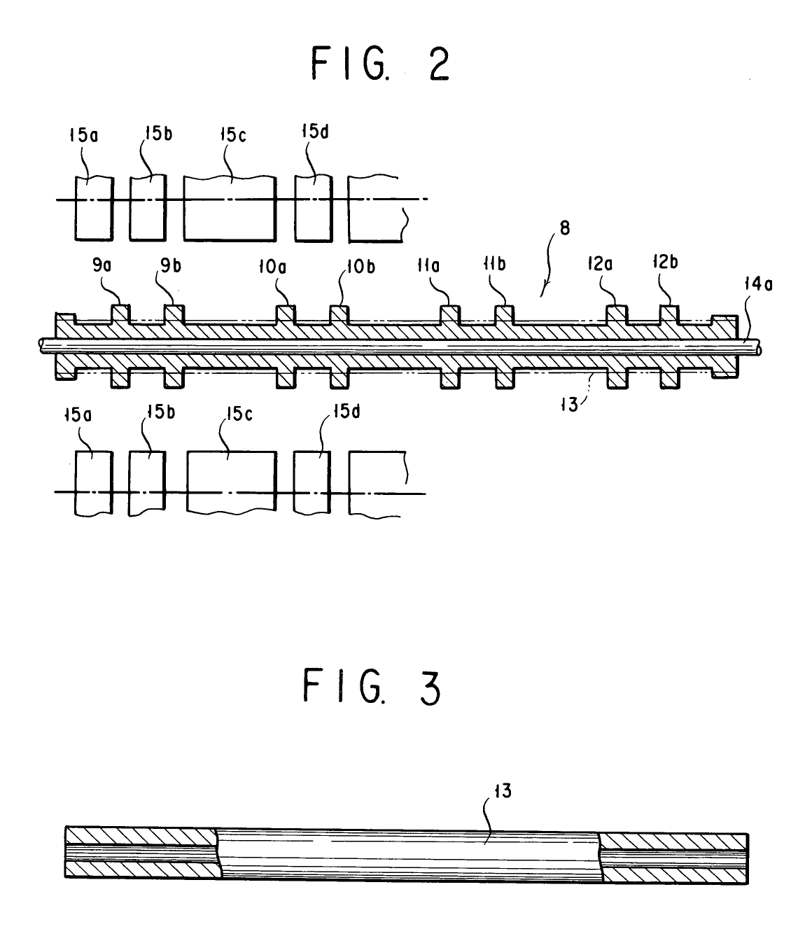

The hollow cam shaft 1 mentioned above is formed from a hollow stepped shaft 8 as shown in FIG. 2 by a forming method in accordance with the present invention.

The hollow stepped shaft 8 has its hollow and is formed with pairs of large diameter portions 9a and 9b, 10a and 10b, 11a and 11b and 12a and 12b to be formed with pairs of the cams 2a-5b, respectively.

The hollow stepped shaft 8 may be formed by mechanical machining from a hollow blank of a selected diameter but for use in the present invention is formed by plastic deformation from a thick hollow blank 13 as shown in FIG. 3.

Specifically, as shown in FIG. 2 the hollow blank 13 has a mandrel 14 inserted in its hollow and then while being rotated is compressed from both sides in directions perpendicular to its axis with rolls 15a, 15b, . . . , corresponding to interspaces between the large diameter portions and to small diameter portions at its both axial ends and outsides of the first and last large diameter portions 9a and 12b and thereby plastically formed so that small diameter portions of a selected diameter are made. Then, when plastically deformed into the small diameter portions, material rises at their both sides forming the large diameter portions 9a-12b of each pair. The larger diameter portions which then have their outer peripheries indeterminate yet are further compressed on these parts to correct their diameter.

In this case, the diameter of each large diameter portion is set up at a value according to a particular size and shape of the stepped portion formed therefrom. In the form of implementation above, this value is made larger than the diameter of the base circle section b and smaller than that of the cam face section a so that a portion left over by forming the base circle section b moves towards the cam face section a.

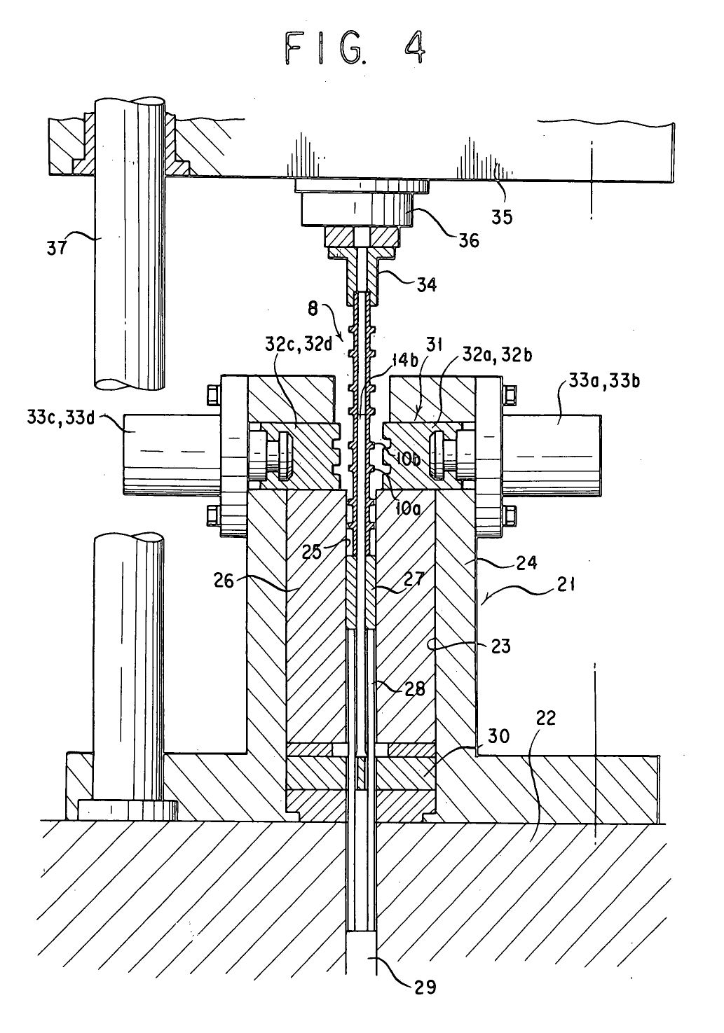

Referring now to FIGS. 4 to 6, mention is next made of a method of and apparatus for forming cam portions of a cam shaft 1 shown in FIG. 1 from such a hollow stepped shaft 8.

In FIG. 4, a cam forming apparatus 21 is shown mounted on a bolster 22 for a pressing machine. The cam forming apparatus 21 has in its axial center section a base block 24 having a cylindrical bore 23 in which an inner block 26 is fitted having a blank insertion hole 25 in the axial center section. In the blank insertion hole 25 an axial knockout 27 is slidably received. The knockout 27 is supported via a knockout pin 28 by a knockout cylinder 29 disposed in the bolster 22 so that it may be moved up and down when the knockout cylinder 29 is telescopically operated up and down. The blank insertion hole 25 has a diameter such that the hollow stepped shaft 8 is fitted so as to be freely movable in it.

The knockout cylinder 29 in operation is made controllable by a controller (e.g., CNC) so that in addition to a usual knockout operation, the knockout 27 may take a plurality of upper preselected positions that can be set. Further, the knockout cylinder 29 in the forming apparatus used in this form of implementation is made capable of compressively forming from below the blank positioned in the forming apparatus via the knockout 27 or alternatively via a lower die in place of the knockout 27.

The knockout 27 has a hole formed therein which is identical in diameter to the hollow of the hollow stepped shaft 8 and through which a mandrel 14b inserted into the hollow of the hollow stepped shaft 8 is passed. And, the mandrel 14b is supported on a mandrel block 30 mounted under the inner block 26. Further, the knockout pin 28 is passed through the mandrel block 30.

A cam forming die unit 31 is mounted on the base block 24 coaxially therewith. The cam forming die unit 31 comprises a first, a second, a third and a fourth forming die 32a, 32b, 32c and 32d which are movable towards and away from the axial center of the base block 24 from four horizontal directions, respectively, and cam forming cylinders 33a, 33b, 33c and 33d for causing them to be so moved, respectively.

Above the cam forming die unit 31 of the cam forming apparatus 21, a chuck 34 is disposed as attached to a slide 35 of the pressing machine to hold the upper end of the hollow stepped shaft 8 set on the cam forming apparatus 21 coaxially therewith and with the cam forming die unit 31. The chuck 34 is attached to the slide 35 via an index device 36 which can be operated to set the angle of the chuck 34 about the axial center as desired. A guide post 37 of the pressing machine is also shown.

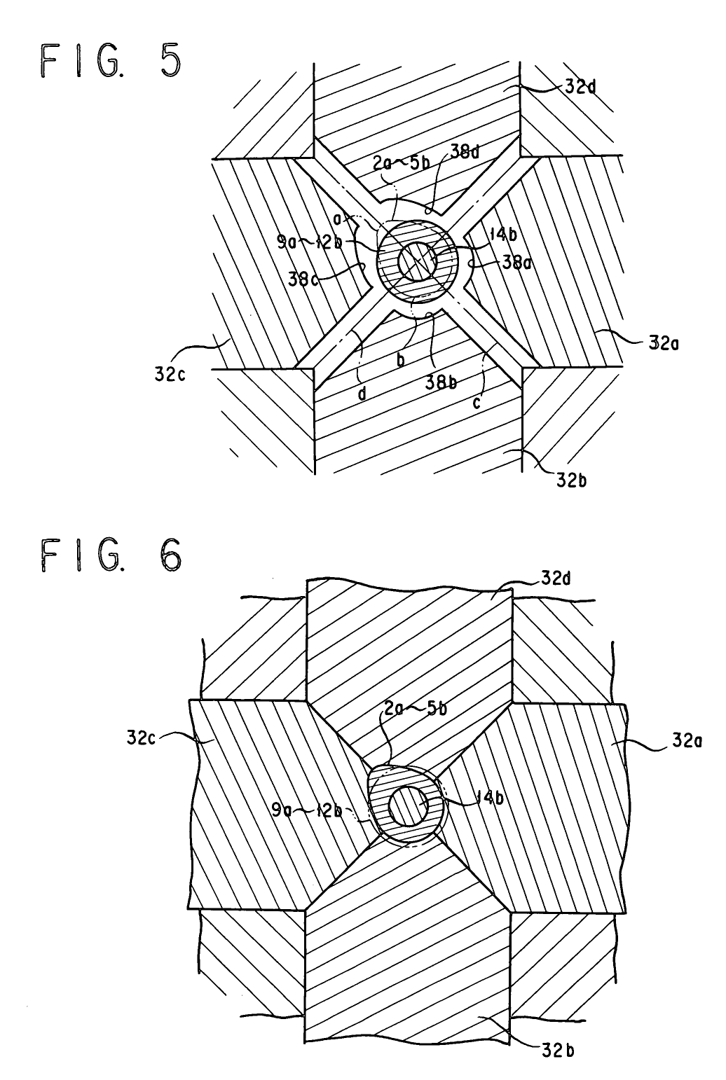

The first to fourth forming dies 32a to 32d as shown in FIG. 5 are arranged to form a cavity 38 in a region of their tips and correspond to first to fourth areas of the cavity 38, respectively, which are defined by a line c that connects the apexes of the cam face a and base circle b sections and a line d that is perpendicular to the line c and passes through the axis of the shaft 8. Thus, the first forming die 32a is formed on its tip with a first cavity wall 38a, i.e., a first contour of the cavity 38, for forming a first portion of profile that is on the right hand side of the base circle section b to the line c connecting the apexes up to the line d. Likewise, the second forming die 32b is formed on its chip with a second cavity wall 38b, i.e., a second con-tour of the cavity 38, for forming a second portion of profile that is on the left hand side of the base circle section b up to the line d. And, the third forming die 32c is formed on its tip with a third cavity wall 38c, i.e., a third contour of the cavity 38, for forming a third portion of profile that is on the left hand side of the cam face a to the line c connecting the apexes up to the line d. Likewise, the fourth forming die 32d is formed on its tip with a fourth cavity wall 38d, i.e., a fourth contour of the cavity 38, for forming a fourth portion of profile that is on the right hand side of the cam face section a up to the line d.

If cams as of a hollow cam shaft 1 shown in FIG. 1 are paired on the shaft with two cams of each pair spaced apart by a journal portion 6, the cavity 38 for the forming dies 32a to 32d are vertically provided at each of two places vertically spaced apart by a distance for the journal portion as shown in FIG. 4 and opposite sides of each of two such cavities correspond to small diameter portions (including the journal portion) of the shaft on opposite sides of each of two cams as vertically.

Mention is now made of a method of forming a hollow cam shaft 1 using the cam forming apparatus 21 constructed as mentioned above.

Into the cam forming apparatus 21 with each of the forming dies 32a to 32d in an open state in the cam forming die unit 31, a hollow stepped shaft 8 is loaded by placing its lower end in contact with the knockout 27 while holding its upper end with the chuck 34. Then, the knockout cylinder 29 and the slide 35 are synchronously operated to move up and down the knockout 27 and the chuck 34 together for positioning the blank shaft 8 relative to the forming die unit 31. Then, as shown in FIG. 4, assume that the second large diameter portions 10a and 10b, for example, are each juxtaposed with the cavity walls or contours 38a to 38d of the forming dies 32a to 32d in the forming die unit 31.

The cam forming cylinders 33a to 33d are then operated to bring the forming dies 32a to 32d into a compression state as shown in FIG. 6 from the die open state shown in FIG. 5, thereby forming second cams 3a and 3b. Then, while the cams are formed each in a single stroke of the forming dies 32a to 32d, the first and second forming dies 32a and 32b for forming the cam base circle section b are operated several seconds (e.g., four seconds) earlier than the third and fourth forming dies 32c and 32d for forming the cam face section a.

This causes a part of the blank for the base circle section b to be deformed so as to become smaller than the diameter of the larger diameter portions 9a to 11b of the hollow stepped shaft 8 and then a material left over by the deformation to be better moved towards the cam face section a side by the third and fourth forming dies 32c and 32d operated later than the first and second forming dies 32a and 32b, forming the cam face section a.

Subsequently, the cam forming die unit 31 is opened and thereafter the knockout 27 and the chuck 34 together are moved up and down to move the hollow stepped shaft 8 up and down, thereby juxtaposing, e.g., the fourth large diameter portions 12a of it with the cavity walls or contours 38a to 38d of the forming dies 32a to 32d in the forming die unit 31. At the same time, the index device 36 is operated to rotate the hollow stepped shaft 8 by an angle about the axis from its position of the second cams 3a and 3b which have been formed at the first time to establish a next cam angular position. Thereafter, operating the cam forming die unit 31 as in the manner of the first time allows the fourth set of cams 12a and 12b to be formed.

Repeating the operation permits forming the first and third sets of cams 2a and 2b; and 4a and 4b. In forming each set of cams 2a to 5b, the hollow stepped shaft 8 is axially moved while the mandrel 14b remains fixed at the position to juxtapose with the cam forming die unit 31 constantly to act to back up the hollow stepped shaft 8.

Forming here is performed in a closed state within a cavity 38 defined with the cavity walls or contours 38a-38d of the forming dies 32a-32d and namely effected as closed. As a result, the bulk of a large diameter portion 9a-12b remains identical to its volume after it has been plastically deformed by the cavity walls 38a-38d, and each cam 2a-5b is formed with no surplus left over within the cavity. Further, in the forming of each cam, the forming dies 32a-32d can be operated enough in a single stroke but may be in a plurality of strokes depending on particular size and profile in cross-section of the step-profiled portion to be formed.

Forming by forging each of the cams 2a-5b in the cam forming die unit 31 is effected in the cold. And, the operation of the cam forming cylinders 33a-33d operating the cam forming dies 32a-32d, respectively, of the cam forming die unit 31 is controlled under CNC so that the stop position, motion speed and compression force of each forming die 32a-32d can be controlled as desired. Also, the knockout cylinder 29 that operates the knockout 27 and also the slide 35 are operated likewise under CNC so that the hollow stepped shaft 8 can be precisely positioned in its axial direction with respect to the cam forming die unit 31 in forming each stepped cam.

Also, the index device 36 that rotates for indexing the hollow stepped shaft 8 over a selected angle relative to a reference angle each time the cam in each step is formed, can be operated with high precision under CNC.

Further, if in the forms of implementation illustrated, cams are identical in angle of orientation about the axis, then the chuck 34 is directly fastened to the slide 35 without using the index device 36. The chuck 34 typically uses a plurality of claws with which to hold an axial end of the sock mechanically but may be an electromagnetic attractor; in short it may be any holder means that is capable of holding an end of the blank detachably.

Also, even if cams on a hollow cam shaft 1 are different in angle of orientation about its axis, if such a difference in angle is a simple value, without using the index device the slide 35 may be directly fastened to the holder means with the holder means altered by selected angles. Further, while in the forms of implementation illustrated a mandrel 14b is shown inserted in the hollow of a hollow stepped shaft 8, there is also the case that the mandrel 14b is not used.

Further, while the cam forming die unit 31 is shown using the four forming dies 32a-32d, namely those movable in four directions transverse to its axis, they may be three or at least five forming dies, namely those movable in three or at least five directions transverse to its axis depending on particular profile and size of a step-profiled proportion to be formed.

And, while the forms of implementation illustrated is shown forming a hollow cam shaft formed with cams on its stepped portions, the profile to be imparted to the stepped portions is not limited to those of automotive cams but may be any of various profiles.

In addition to the forms of implementation illustrated, the present invention is applicable, among others, to forming an inte-grated common rail for direct injection in a diesel engine.

1. A method of forming a hollow step-profiled shaft, comprising the steps of:
preparing a hollow stepped shaft having its axis and large diameter portions intermediate axially between its ends;
compressing a large diameter portion of the shaft with forming dies from at least three different directions approximately simultaneously towards said axis; and
shaping the large diameter portion with a profile such as to conform to contours of a cavity formed in a region of tips of the forming dies.

2. A method of forming a hollow step-profiled shaft, comprising the steps of:
preparing a hollow stepped shaft having its axis and a plurality of large diameter portions intermediate axially between its ends;
disposing the hollow stepped shaft in a forming die unit so as to be movable axially and coaxially therewith, the forming die unit having forming dies movable in at least three different directions towards and away from said axis, the forming dies being formed with a cavity in a region of their tips;
moving the hollow stepped shaft axially and coaxially with the forming die unit to bring the large diameter portions successively into juxtaposition with the forming dies in the forming die unit; and
when each of the large diameter portions is brought into juxtaposition with the forming dies, compressing the large diameter portion of the shaft with the forming dies from at least three different directions approximately simultaneously towards said axis to shape the large diameter portion with a profile such as to conform to contours of said cavity.

3. A method of forming a hollow step-profiled shaft as set forth in claim 1 or claim 2, wherein the forming dies include a first forming die for forming a portion of profile that is larger than a diameter of the large diameter portion and a second forming die for forming another portion of profile that is smaller than the diameter of the large diameter portion, the method further comprising the step of operating the first forming die in precedence to the second forming die.

4. A method of forming a hollow step-profiled shaft as set forth in claim 2, wherein each succeeding large diameter portion is formed with a profile upon rotating the hollow stepped shaft by a selected angle about the axis to alter a forming position for its preceding large diameter portion.

5. A method of forming a hollow step-profiled shaft as set forth in any one of claims 1, 2, and 4, wherein the hollow stepped shaft has a mandrel inserted in its hollow when a large diameter portion thereon is formed with a profile.

6. A method of forming a hollow step-profiled shaft as set forth in claim 1 or claim 2, wherein the forming die moves in three different directions, respectively.

7. A method of forming a hollow step-profiled shaft as set forth in Claim 1 or claim 2, wherein the forming die moves in four different directions, respectively.

8. A method of forming a hollow step-profiled shaft as set forth in claim 1 or claim 2, wherein the forming die moves in at least five different directions, respectively.

9. An apparatus for forming a hollow step-profiled shaft from a hollow stepped shaft having its axis and large diameter portions axially intermediate between its ends, comprising:
a support member disposed on a bolster in a pressing machine for supporting the lower end of the hollow stepped shaft;
a holder mounted to a slide in the pressing machine for holding the upper end of the hollow stepped shaft; and
a forming die unit disposed on the bolster and having forming dies movable in at least three different directions towards and away from said axis, the forming dies being formed with a cavity in a region of their tips, and a cylinder unit for operating the forming dies.

10. An apparatus for forming a hollow step-profiled shaft from a hollow stepped shaft having its axis and large diameter portions axially intermediate between its ends, comprising:
a step-profiled portion forming apparatus comprising a base block secured to a bolster in a pressing machine having a slide, a knockout cylinder mounted in the bolster, an axial knockout movable up and down by the knockout cylinder and controllable of its vertical position in synchronism with movement of the slide, and a forming die unit disposed above the base block coaxially with the axial knockout and having forming dies movable in at least three different directions towards and away from said axis, the forming dies being formed with a cavity in a region of their tips, and a cylinder unit for operating the forming dies; and
a holder attached to the slide for holding an upper end of the hollow stepped shaft supported on the knockout.

11. An apparatus for forming a hollow step-profiled shaft as set forth in claim 10, further comprising an indexing device coupled to the holder so that it is capable of rotating the holder about its axis for indexing.

12. An apparatus for forming a hollow step-profiled shaft as set forth in claim 10 or claim 11, further comprising a mandrel passed through the axial knockout for insertion into the hollow of the hollow stepped shaft and a mandrel supporting block disposed in the step-profiled portion forming apparatus.

13. An apparatus for forming a hollow step-profiled shaft as set forth in claim 9 or claim 10, wherein the forming die moves in three different directions, respectively.

14. An apparatus for forming a hollow step-profiled shaft as set forth in claim 9 or claim 10, wherein the forming die moves in four different directions, respectively.

15. An apparatus for forming a hollow step-profiled shaft as set forth in claim 9 or claim 10, wherein the forming die moves in at least five different directions, respectively.

16. A method of forming a hollow step-profiled shaft as set forth in claim 3, wherein the hollow stepped shaft has a mandrel inserted in its hollow when a large diameter portion thereon is formed with a profile.
